(19) United States
(12) Patent Application Publication
(10) Pub. No.: US 2016/0173928 A1
(43) Pub. Date: Jun. 16, 2016

(54) IN-VEHICLE MULTIMEDIA SYSTEM FOR EFFICIENTLY SEARCHING FOR DEVICE AND METHOD FOR CONTROLLING THE SAME

(71) Applicant: Hyundai Motor Company, Seoul (KR)

(72) Inventor: Young Kwan Lee, Gwacheon (KR)

(21) Appl. No.: 14/696,530

(22) Filed: Apr. 27, 2015

(30) Foreign Application Priority Data
Dec. 11, 2014 (KR) 10-2014-0178154

(51) Int. Cl. H04N 21/414; H04W 8/00; H04N 21/41; H04N 21/232

(52) U.S. Cl. CPC H04N 21/41422; H04N 21/232; H04W 8/005; H04N 21/4126

(57) ABSTRACT

A method for searching for a content server for content sharing in a content player includes: wirelessly connecting the content player to the content server; transmitting, a first time, a search request message to the content server; transmitting, a second time, the search request message to the content server, when a search response message to the first transmitted search request message is not received within a first waiting time; and repeating the first transmission of the search request message and the second transmission of the search request message a predetermined number of times until the search response message is received, when the search response message to the second transmitted search request message is not received within a second waiting time differing from the first waiting time.

### CROSS-REFERENCE TO RELATED APPLICATION

This application claims priority to and the benefit of Korean Patent Application No. 10-2014-0178154, filed on Dec. 11, 2014, which is hereby incorporated by reference as if fully set forth herein.

### BACKGROUND

1. Technical Field

The present disclosure relates generally to an in-vehicle multimedia system for efficiently searching for a device, and more particularly, to an in-vehicle multimedia system for efficiently searching for an external device to provide content to the in-vehicle multimedia system.

2. Discussion of the Related Art

Recently, development of smart devices, which may share or reproduce various types of content, such as video, music, image, and the like, between multimedia devices, has increased dramatically. In this regard, the digital living network alliance (DLNA) is a representative technology for sharing and reproducing content between devices that allows a smart device, such as a smartphone, for example, to transmit a content source file (e.g., a video/moving picture file) over a Wi-Fi connection to an in-vehicle multimedia system so as to be reproduced by the in-vehicle multimedia system. Here, an in-vehicle multimedia device which reproduces content based on DLNA (e.g., an in-vehicle audio-video-navigation (AVN) system) may be referred to as a digital media player (DMP), while a device which possesses content (e.g., a smartphone) may be referred to as a digital media server (DMS).

FIG. 1 is a schematic view illustrating an example of a general process of performing content sharing through DLNA. With reference to FIG. 1, when an in-vehicle AVN system 100 serving as a DMP and a mobile device 200 serving as a DMS are connected via Wi-Fi through a procedure defined in DLNA, the DMP may search for contents possessed by the DMS. Further, content sharing between two devices is carried out by a method in which, when the DMP selects content desired to be reproduced and requests the selected content from the DMS during search, the DMS transmits the content desired to be reproduced to the DMP. In order to perform content search/request/provision, as exemplarily shown in FIG. 1, the DMP first needs to be ready to search for the DMS, and the DMS needs to be ready to respond to the request from the DMP. A process therefor will be described with reference to FIG. 2.

FIG. 2 is a flowchart illustrating an example of a general process for searching for a DMS in a DMP through DLNA. With reference to FIG. 2, first, the DMP and the DMS may be connected through Wi-Fi (Operation S210). In such a state, the DMP may transmit an M-search request to search for the DMS to the DMS (Operation S220). When the DMS receives the M-search request, the DMS may transmit an M-search ACK message to the DMP so as to respond to the M-search request (Operation S230). The operating state of the DMP according to the above-described request and response will be described with reference to FIG. 3.

FIG. 3 contains views illustrating an example of a general form of displaying a result of searching for an external device in an in-vehicle AVN system. The in-vehicle AVN system may transmit an M-search request message to the DMS one time automatically according to execution of a sharing function using DLNA or when a device refresh menu 310 is selected in the in-vehicle AVN system, as exemplarily shown in section (a) of FIG. 3. If the in-vehicle AVN system does not receive a response to the M-search request from the DMS, a searched device is not displayed, as exemplarily shown in section (b) of FIG. 3, and if the in-vehicle AVN system receives a response to the M-search request from the DMS, information 320 regarding a device having transmitted a corresponding response message may be displayed in the in-vehicle AVN system.

In the present DLNA standard technology, a maximum allowable time taken for the DMS to transmit an M-search ACK message in response to an M-search request message after reception of the M-search request message is not defined. Therefore, when a DMP desires to search for a DMS connected to the DMP through Wi-Fi, performing the search of the DMS according to response characteristics of the DMS can be difficult, and a device search interoperability problem may arise, in which a device research result is different according to the number of trials during the search of the DMS in the DMP.

### SUMMARY

Accordingly, the present disclosure is directed to an in-vehicle multimedia system for efficiently searching for a device and a method for controlling the same that substantially obviate one or more problems due to limitations and disadvantages of the related art.

An object of the present disclosure is to provide an in-vehicle multimedia system which may more efficiently search for a device to provide content and a control method thereof. Another object of the present disclosure is to provide a method for raising the success rate of searching for a DMS in a DMP.

Additional advantages, objects, and features of the present disclosure will be set forth in part in the description which follows and in part will become apparent to those having ordinary skill in the art upon examination of the following or may be learned from practice of the disclosed embodiments. The objectives and other advantages of the present disclosure may be realized and attained by the structure particularly pointed out in the written description and claims hereinbelow, as well as the appended drawings.

To achieve these objects and other advantages and in accordance with the purpose of the present disclosure, as embodied and broadly described herein, a method for searching for a content server for content sharing in a content player includes: wirelessly connecting the content player to the content server; transmitting, a first time, a search request message to the content server; transmitting, a second time, the search request message to the content server, when a search response message to the first transmitted search request message is not received within a first waiting time; and repeating the first transmission of the search request message and the second transmission of the search request message a predetermined number of times until the search response message is received, when the search response message to the second transmitted search request message is not received within a second waiting time differing from the first waiting time.

The method may further include waiting for reception of the search response message for a third waiting time longer than the first waiting time and the second waiting time, when the search response message is not received during the repeating of the first transmission of the search request message and the second transmission of the search request message for the predetermined number of times.

The first transmission of the search request message may be performed when a user inputs a device refresh command.

The first transmission of the search request message may be performed after a fourth waiting time from the input of the device refresh command has elapsed.

The content sharing may be performed through digital living network alliance (DLNA).

The content player may correspond to a DLNA-based digital media player (DMP), and the content server may correspond to a DLNA-based digital media server (DMS).

The search request message may be an M-search request message, and the search response message may be an M-search ACK message.

The content player may include an in-vehicle audio-video-navigation (AVN) system.

Furthermore, according to embodiments of the present disclosure, a content player system for searching for a content server for content sharing includes: a wireless communication unit configured to wirelessly exchange data with the content server; and a controller configured to: i) transmit, a first time, a search request message to the content server, ii) transmit, a second time, the search request message to the content server, when a search response message to the first transmitted search request message is not received within a first waiting time, and iii) repeat the first transmission of the search request message and the second transmission of the search request message a predetermined number of times until the search response message is received, when the search response message to the second transmitted search request message is not received within a second waiting time differing from the first waiting time.

The controller may be further configured to wait for reception of the search response message for a third waiting time longer than the first waiting time and the second waiting time, when the search response message is not received during the repeating of the first transmission of the search request message and the second transmission of the search request message for the predetermined number of times.

The controller may be further configured to perform the first transmission of the search request message when a user inputs a device refresh command.

The controller may be further configured to perform the first transmission of the search request message after a fourth waiting time from the input of the device refresh command has elapsed.

The content sharing may be performed through digital living network alliance (DLNA).

The content player may correspond to a DLNA-based digital media player (DMP), and the content server may correspond to a DLNA-based digital media server (DMS).

The search request message may be an M-search request message, and the search response message may be an M-search ACK message.

The content player may include an in-vehicle audio-video-navigation (AVN) system.

Furthermore, according to embodiments of the present disclosure, a method for searching for a content server for content sharing in a content player includes: wirelessly connecting the content player to the content server; transmitting, a first time, a search request message to the content server after a first waiting time has elapsed; transmitting, a second time, the search request message to the content server after a second waiting time has elapsed; waiting for reception of a search response message for a third waiting time; repeating the first transmission of the search request message, the second transmission of the search request message, and the waiting for reception of the search response message a predetermined number of times, when the search response message is not received before the third waiting time elapses; and waiting for reception of the search response message for a fourth waiting time, when the search response message is not received before the repetition is terminated.

Furthermore, according to embodiments of the present disclosure, a non-transitory computer readable medium containing program instructions for searching for a content server for content sharing in a content player includes: program instructions that wirelessly connect the content player to the content server; program instructions that transmit, a first time, a search request message to the content server; program instructions that transmit, a second time, the search request message to the content server, when a search response message to the first transmitted search request message is not received within a first waiting time; and program instructions that repeat the first transmission of the search request message and the second transmission of the search request message a predetermined number of times until the search response message is received, when the search response message to the second transmitted search request message is not received within a second waiting time differing from the first waiting time.

Furthermore, according to embodiments of the present disclosure, a non-transitory computer readable medium containing program instructions for searching for a content server for content sharing in a content player includes: program instructions that wirelessly connect the content player to the content server; program instructions that transmit, a first time, a search request message to the content server after a first waiting time has elapsed; program instructions that transmit, a second time, the search request message to the content server after a second waiting time has elapsed; program instructions that wait for reception of a search response message for a third waiting time; program instructions that repeat the first transmission of the search request message, the second transmission of the search request message, and the waiting for reception of the search response message a predetermined number of times, when the search response message is not received before the third waiting time elapses; and program instructions that wait for reception of the search response message for a fourth waiting time, when the search response message is not received before the repetition is terminated.

It is to be understood that both the foregoing general description and the following detailed description of the present disclosure are exemplary and explanatory and are intended to provide further explanation of the embodiments as claimed.

### BRIEF DESCRIPTION OF THE DRAWINGS

The accompanying drawings, which are included to provide a further understanding of the present disclosure and are incorporated in and constitute a part of this application, illustrate embodiments of the present disclosure and together with the description serve to explain the principle of the disclosure. In the drawings:

FIG. 1 is a schematic view illustrating one example of a general process of performing content sharing through DLNA;

FIG. 2 is a flowchart illustrating one example of a general process for searching for a DMS in a DMP through DLNA;

FIG. 3 contains views illustrating one example of a general form of displaying a result of searching for an external device in an in-vehicle AVN system;

FIG. 4 is a flowchart illustrating one example of an operating process of a DMP in accordance with embodiments of the present disclosure;

FIG. 5 contains views illustrating one example of a request message transmission pattern in accordance with embodiments of the present disclosure; and

FIG. 6 is a block diagram illustrating one example of the configuration of an in-vehicle AVN system in accordance with embodiments of the present disclosure.

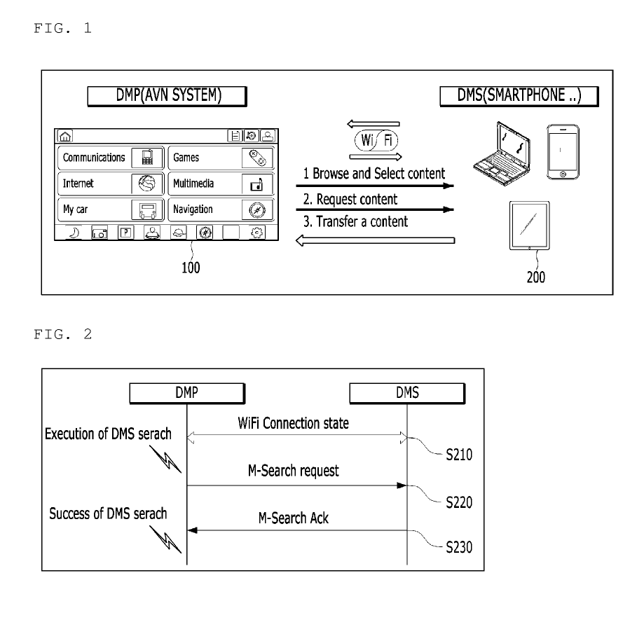

### DETAILED DESCRIPTION OF THE EMBODIMENTS

Reference will now be made in detail to embodiments of the present disclosure, examples of which are illustrated in the accompanying drawings. In the drawings, the same or similar elements are denoted by the same reference numerals even though they are depicted in different drawings, and a detailed description thereof will be omitted. The suffixes “module” and “unit” in elements used in the description below are given or used together only in consideration of ease in preparation of the specification and do not have distinctive meanings or functions.

In the following description of embodiments of the present disclosure, a detailed description of known functions and configurations incorporated herein will be omitted when it may make the subject matter of the present disclosure rather unclear. Further, the accompanying drawings have been made only for a better understanding of the embodiments of the present disclosure. It will be appreciated that the technical spirit disclosed in the specification is not restricted by the accompanying drawings and includes various modifications, equivalents, and substitutions, without departing from the scope and spirit of the disclosed embodiments as disclosed in the accompanying claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Referring now to the disclosed embodiments, as described above, cases where a DMP does not receive a response message corresponding to a transmitted M-search request message from a DMS for various reasons frequently arise. Therefore, the embodiments of the present disclosure divide search failures into three situations and propose sequential execution of solutions to the respective situations.

First, three failure situations will be described. The three failure situations include: a situation 1) in which a response to a request message transmitted one time when a DMS is first searched for is not received for whatever reason; a situation 2) in which a point of time when the DMP retransmits the request message and a point of time when the DMS transmits the response message overlap and thus the two messages collide with each other; and a situation 3) in which different response times are generated according to characteristics of the DMS during re-search of the DMS (e.g., a case in which the request message is retransmitted a specific device prior to lapse of a response time of the device, for example, 20 seconds). Thus, the disclosed embodiments propose that 1) the request message is additionally retransmitted as preparation for failure of the request message transmitted one time, 2) the request message is retransmitted at variable intervals so as to prevent message collision, 3) retransmission of the request message is stopped for a designated time and the response message is waited after retransmission of the request message is carried out a predetermined number of times in consideration of characteristics of the DMS.

Now, an operating process of a DMP through the above-described procedure will be described.

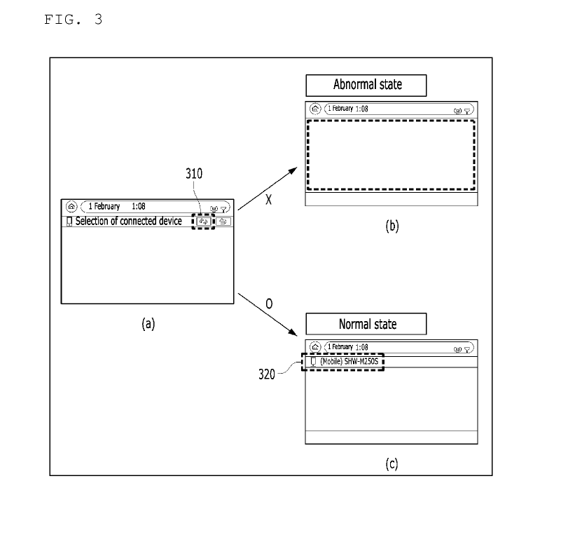

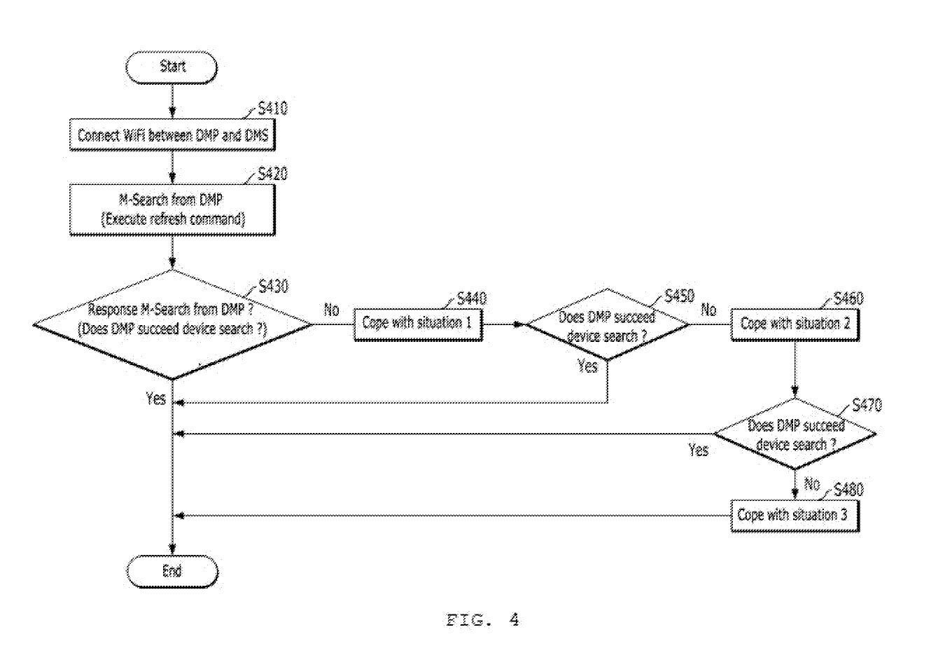

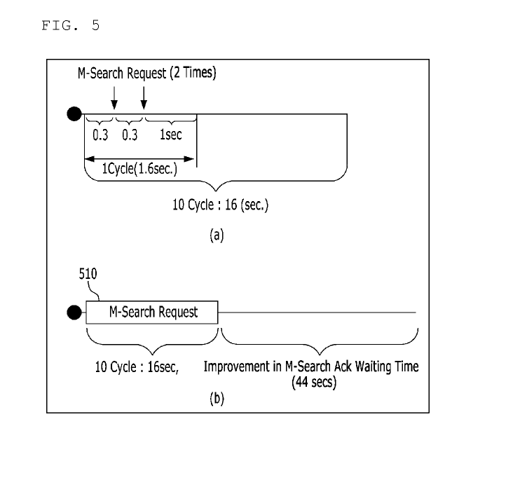

FIG. 4 is a flowchart illustrating one example of an operating process of a DMP in accordance with embodiments of the present disclosure. With reference to FIG. 4, a DMP and a DMS may be connected to each other through Wi-Fi (Operation S410). When a content sharing function through DLNA is firstly executed or as a user inputs a device refresh command, the DMP transmits an M-search request message (Operation S420) and waits for reception of an M-search ACK message from the DMS (Operation S430). If an M-search ACK message is received, a content list of the DMS, having transmitted the M-search ACK message, may be displayed, as exemplarily shown in section (c) of FIG. 3, and content sharing may be started through a similar process to the process shown in FIG. 1.

If an M-search ACK message to the first transmitted M-search request message is not received, the DMP automatically retransmits the M-search request message (Operation S440). If an M-search ACK message to the retransmitted M-search request message is not received (Operation S450), the DMP may retransmit the M-search request message a predetermined number of times at different transmission intervals (Operation S460). Nonetheless, if an M-search ACK message to the retransmitted M-search request message is not received (Operation S470), the DMP may stop retransmission of the M-search request message and wait for reception of the M-search ACK message for a designated time (Operation S480). When an M-search ACK message is received at any time during the respective operations S440, S460 and S480, the process of FIG. 4 may be ended as a success of search.

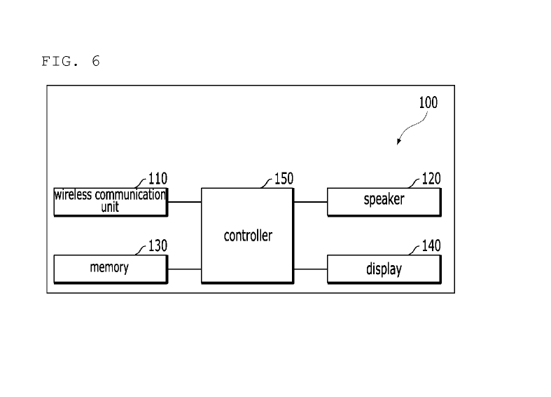

The above-described process with reference to FIG. 4 may be defined as one pattern. This will be described with reference to FIG. 5. FIG. 5 contains views illustrating one example of an M-search request message transmission pattern in accordance with embodiments of the present disclosure.

With reference to section (a) of FIG. 5, an operating pattern to cope with the above-referenced situation 1) and the situation 2) is illustrated. In more detail, an M-search request message is first transmitted 0.3 seconds after input of an M-search request message transmission command and then, the M-search request message is retransmitted after 0.3 seconds. That is, if a response to the first transmitted M-search request message is not received within 0.3 seconds after transmission, retransmission is carried out after 0.3 seconds as a measure to cope with the situation 1).

Thereafter, waiting is carried out for 1 second and thus, one cycle of 1.6 seconds is terminated. At the next cycle, waiting is carried out for 0.3 seconds and then a first M-search request message in this cycle is transmitted. Therefore, a waiting time of 1.3 seconds is substantially present between the second transmission of the M-search request message and the third of the M-search request message. This may mean generation of different waiting times, i.e., 0.3 seconds and 1.3 seconds, and thus mean execution of a measure to cope with the situation 2) (i.e., prevention of collision between messages). This cycle may be repeated 10 times at maximum if a response message is not received during the process, and be stopped at any time if a response message is received during the process.

Thereafter, with reference to section (b) of FIG. 5, if an M-search ACK message is not received until the cycle shown in section (a) of FIG. 5 is repeatedly performed 10 times 510, it is judged that the situation 3) is generated. Therefore, transmission of the M-search request message is stopped for a designated time (here, 44 seconds, as an example) and waiting for M-search ACK messages. This ensures a sufficient response message reception waiting time to receive M-search ACK messages from devices having different response times.

Through the above-described process, even if a user presses a refresh button one time, the DMP repeatedly transmits a request message at different transmission intervals a predetermined number of times for 1 minute and then waits for responses for a designated time, thus improving a search success rate. As a result of experimentation executed by the applicant using various commercially available smartphones as DMSs through the pattern shown in FIG. 5, it may be confirmed that response reception rates for 1 minute are raised from 10% to 90%.

Next, the configuration of an apparatus to implement embodiments of the present disclosure will be described.

FIG. 6 is a block diagram illustrating one example of the configuration of an in-vehicle AVN system in accordance with embodiments of the present disclosure. With reference to FIG. 6, an in-vehicle audio-video-navigation (AVN) system 100 serving as a DMP may include a wireless communication unit 110 connected to a communication device, such as a smartphone, through a wireless communication method, such as Bluetooth or Wi-Fi, and performing transmission/reception of search request/response messages based on DLNA, search of content desired to be shared, and sharing of a control signal for selection and the content desired to be shared, a speaker 120 to output sound of the content to be shared, sound regarding execution of a navigation function and/or voice of a counterpart during execution of a hands-free function, a memory 130 to store map information for a navigation system, multimedia content, set information and the like, a display 140 to store the map information for the navigation system, image information of the multimedia content, and/or a search state of a DMS or a content list of the DMS, and a controller 150 to control the above-described elements and to execute judgment and calculation required to implement the embodiments. For example, the controller 150 may transmit a request message, until a response message is received in the pattern shown in FIG. 5, and may control the overall process of sharing content with a DMS having transmitted the corresponding response message when the response message is received.

The above-described embodiments may be recorded in a computer readable storage medium in which programs are recorded, as computer readable code. Computer readable storage media include all kinds of storage devices in which data readable by a computer system is stored. For example, computer readable media include a hard disk drive (HDD), a solid state disk (SSD), a silicon disk drive (SDD), a ROM, a RAM, a CD-ROM, a magnetic tape, a floppy disk, optical storage media and the like, and may be implemented in the form of a carrier wave (e.g., transmission via the Internet).

As apparent from the above description, the embodiments of the present disclosure have effects as described below.

A device which will provide content may be more efficiently searched for. In particular, since search trials having different intervals are repeated several times and additional waiting times are given, a response message coping with collision between messages or different response times of respective devices may be received.

It will be apparent to those skilled in the art that various modifications and variations can be made in the present disclosure without departing from the spirit or scope of the disclosure. Thus, it is intended that the present disclosure covers the modifications and variations of the disclosed embodiments provided they come within the scope of the appended claims and their equivalents.

What is claimed is:

1. A method for searching for a content server for content sharing in a content player, comprising:
wirelessly connecting the content player to the content server;
transmitting, a first time, a search request message to the content server;
transmitting, a second time, the search request message to the content server, when a search response message to the first transmitted search request message is not received within a first waiting time; and
repeating the first transmission of the search request message and the second transmission of the search request message a predetermined number of times until the search response message is received, when the search response message to the second transmitted search request message is not received within a second waiting time differing from the first waiting time.

2. The method according to claim 1, further comprising:
waiting for reception of the search response message for a third waiting time longer than the first waiting time and the second waiting time, when the search response message is not received during the repeating of the first transmission of the search request message and the second transmission of the search request message for the predetermined number of times.

3. The method according to claim 1, wherein the first transmission of the search request message is performed when a user inputs a device refresh command.

4. The method according to claim 3, wherein the first transmission of the search request message is performed after a fourth waiting time from the input of the device refresh command has elapsed.

5. The method according to claim 1, wherein the content sharing is performed through digital living network alliance (DLNA).

6. The method according to claim 5, wherein the content player corresponds to a DLNA-based digital media player (DMP), and the content server corresponds to a DLNA-based digital media server (DMS).

7. The method according to claim 5, wherein the search request message is an M-search request message, and the search response message is an M-search ACK message.

8. The method according to claim 1, wherein the content player includes an in-vehicle audio-video-navigation (AVN) system.

9. A content player system for searching for a content server for content sharing, comprising:
a wireless communication unit configured to wirelessly exchange data with the content server; and
a controller configured to: i) transmit, a first time, a search request message to the content server, ii) transmit, a second time, the search request message to the content server, when a search response message to the first transmitted search request message is not received within a first waiting time, and iii) repeat the first transmission of the search request message and the second transmission of the search request message a predetermined number of times until the search response message is received, when the search response message to the second transmitted search request message is not received within a second waiting time differing from the first waiting time.

10. The content player system according to claim 9, wherein the controller is further configured to wait for reception of the search response message for a third waiting time longer than the first waiting time and the second waiting time, when the search response message is not received during the repeating of the first transmission of the search request message and the second transmission of the search request message for the predetermined number of times.

11. The content player system according to claim 9, wherein the controller is further configured to perform the first transmission of the search request message when a user inputs a device refresh command.

12. The content player system according to claim 11, wherein the controller is further configured to perform the first transmission of the search request message after a fourth waiting time from the input of the device refresh command has elapsed.

13. The content player system according to claim 9, wherein the content sharing is performed through digital living network alliance (DLNA).

14. The content player system according to claim 13, wherein the content player system corresponds to a DLNA-based digital media player (DMP), and the content server corresponds to a DLNA-based digital media server (DMS).

15. The content player system according to claim 13, wherein the search request message is an M-search request message, and the search response message is an M-search ACK message.

16. The content player system according to claim 9, wherein the content player system includes an in-vehicle audio-video-navigation (AVN) system.

17. A method for searching for a content server for content sharing in a content player, comprising:
wirelessly connecting the content player to the content server;
transmitting, a first time, a search request message to the content server after a first waiting time has elapsed;
transmitting, a second time, the search request message to the content server after a second waiting time has elapsed;
waiting for reception of a search response message for a third waiting time;
repeating the first transmission of the search request message, the second transmission of the search request message, and the waiting for reception of the search response message a predetermined number of times, when the search response message is not received before the third waiting time elapses; and
waiting for reception of the search response message for a fourth waiting time, when the search response message is not received before the repetition is terminated.

18. A non-transitory computer readable medium containing program instructions for searching for a content server for content sharing in a content player, comprising:
program instructions that wirelessly connect the content player to the content server;
program instructions that transmit, a first time, a search request message to the content server;
program instructions that transmit, a second time, the search request message to the content server, when a search response message to the first transmitted search request message is not received within a first waiting time; and
program instructions that repeat the first transmission of the search request message and the second transmission of the search request message a predetermined number of times until the search response message is received, when the search response message to the second transmitted search request message is not received within a second waiting time differing from the first waiting time.

19. A non-transitory computer readable medium containing program instructions for searching for a content server for content sharing in a content player, comprising:
program instructions that wirelessly connect the content player to the content server;
program instructions that transmit, a first time, a search request message to the content server after a first waiting time has elapsed;
program instructions that transmit, a second time, the search request message to the content server after a second waiting time has elapsed;
program instructions that wait for reception of a search response message for a third waiting time;
program instructions that repeat the first transmission of the search request message, the second transmission of the search request message, and the waiting for reception of the search response message a predetermined number of times, when the search response message is not received before the third waiting time elapses; and
program instructions that wait for reception of the search response message for a fourth waiting time, when the search response message is not received before the repetition is terminated.
